(19) United States
(12) Patent Application Publication
(10) Pub. No.: US 2023/0330887 A1
(43) Pub. Date: Oct. 19, 2023

(54) INKJET BASED ROLL WITH PUNCH-OUT CARDS

(71) Applicant: Bill Waugh, Lawrenceville, GA (US)

(72) Inventor: Bill Waugh, Lawrenceville, GA (US)

(21) Appl. No.: 18/134,566

(22) Filed: Apr. 13, 2023

Related U.S. Application Data
(60) Provisional application No. 63/330,758, filed on Apr. 13, 2022.

(51) Int. Cl. B26F 1/02; B42D 5/02; B26F 1/00

(52) U.S. Cl. CPC B26F 1/02; B42D 5/027; B26F 1/0092

(57) ABSTRACT

Implementations of an inkjet based roll with punch-out cards comprising a carrier sheet having a top side and a bottom side, where the carrier sheet comprises a plurality of cut-outs, where for each cut-out, a patch/tape is applied to the bottom-side of the carrier sheet to cover the cut-out, and a card (e.g., a polyester plastic card) is attached to the patch through the cut-out from the top side of the carrier sheet. In some implementations, the card and the patch comprise perforations to create a punch-out card. In some implementations, the patch/tape is made from an opaque material having an adhesive on a first side on which the card is adhered. In some implementations, a method of using the inkjet based roll with punch-out cards comprises cutting a plurality of holes in a roll of a carrier sheet where the carrier sheet has a top side and a bottom side. In some implementations, the method further comprises applying to the bottom-side of the carrier sheet a patch/tape to cover the cut-out. In some implementations, the method further comprises attaching a card (e.g., a polyester plastic card) to the patch through the cut-out from the top side of the carrier sheet. In some implementations, the method further comprises perforating the patch and the card from the bottom-side of the carrier sheet. In the method, in some implementations, UV light is not used to dry the adhesive of the patch/tape.

### CROSS REFERENCE TO RELATED APPLICATION

This application claims the benefit of U.S. Patent Application Ser. No. 63/330,758, which was filed on Apr. 13, 2022, and is incorporated herein by reference in its entirety.

### TECHNICAL FIELD

This disclosure relates to implementations of an inkjet based roll with punch-out cards.

### BACKGROUND

Prior art punch out cards are toner based. Furthermore, punch out cards are typically produced on sheets for the customer to use and not on a roll. There is a need for a roll having punch out cards for the customer where the roll can be fed to an inkjet printer and then cut into sheets. Furthermore, prior art rolls are typically 11 inches wide thereby limiting the sheets that can be produced. Still further to produce punch out cards, prior art methods perforate the cards from the card side. However, because the card is adhered to the carrier sheet with tape, the cutting device pierces the tape last thereby leaving adhesive on the cutting device.

### BRIEF DESCRIPTION OF THE DRAWINGS

FIG. 1 illustrates an implementation of an example front side of a sheet with attached punch-out card according to the present disclosure.

FIG. 2 illustrates an implementation of an example back side of a sheet with attached punch-out card according to the present disclosure.

FIG. 3 illustrates an implementation of an example exploded view of a sheet with attached punch-out card according to the present disclosure.

FIG. 4 illustrates an implementation of an example sheet with attached punch-out card according to the present disclosure.

FIG. 5 illustrates an implementation of an example roll according to the present disclosure.

FIG. 6 illustrates an implementation of an example method of manufacturing a roll according to the present disclosure.

### DETAILED DESCRIPTION

Implementations of an inkjet based roll with punch-out cards are provided. In some implementations, the inkjet based roll with punch-out cards comprises a carrier sheet having a top side and a bottom side, where the carrier sheet comprises a plurality of cut-outs, where for each cut-out, a patch/tape is applied to the bottom-side of the carrier sheet to cover the cut-out, and a card (e.g., a polyester plastic card) is attached to the patch through the cut-out from the top side of the carrier sheet. In some implementations, the card and the patch comprise perforations to create a punch-out card. In some implementations, the patch/tape is made from an opaque material having an adhesive on a first side on which the card is adhered.

In some implementations, a method of using the inkjet based roll with punch-out cards comprises cutting a plurality of holes in a roll of a carrier sheet where the carrier sheet has a top side and a bottom side. In some implementations, the method further comprises applying to the bottom-side of the carrier sheet a patch/tape to cover the cut-out.

In some implementations, the method further comprises attaching a card (e.g., a polyester plastic card) to the patch through the cut-out from the top side of the carrier sheet. In some implementations, the method further comprises perforating the patch and the card from the bottom-side of the carrier sheet. In the method, in some implementations, UV light is not used to dry the adhesive of the patch/tape.

In some implementations, the manufactured inkjet based roll with punch-out cards can be fed into a press, printed thereon, cut, etc.

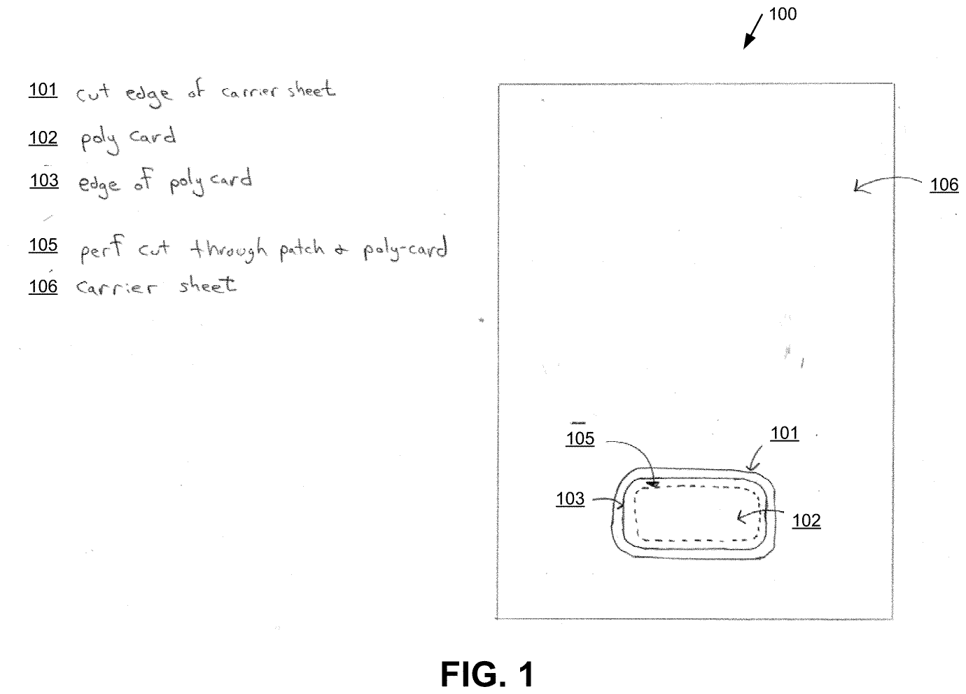

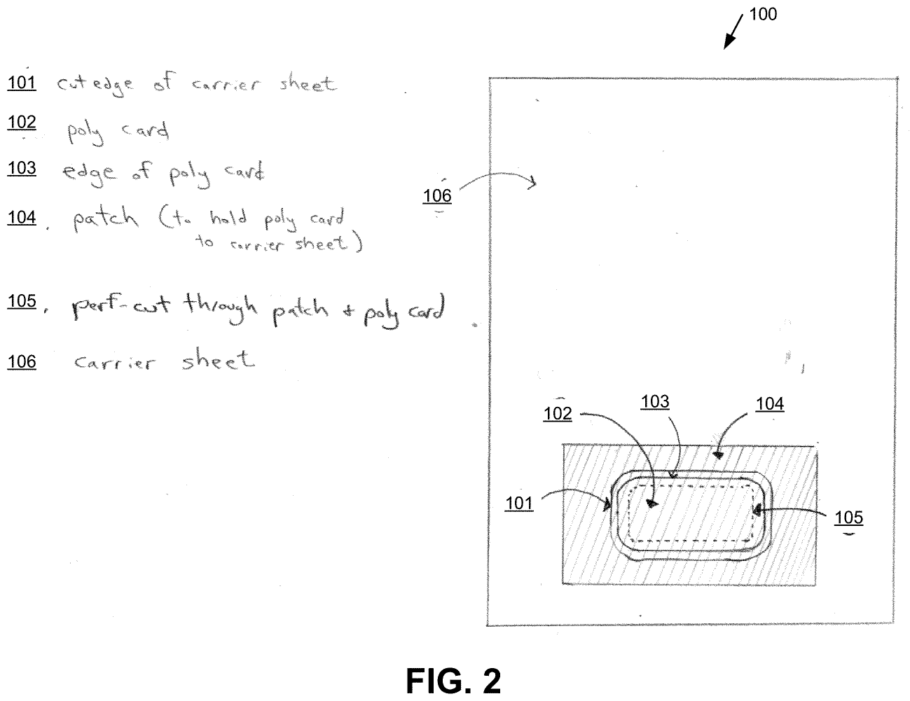

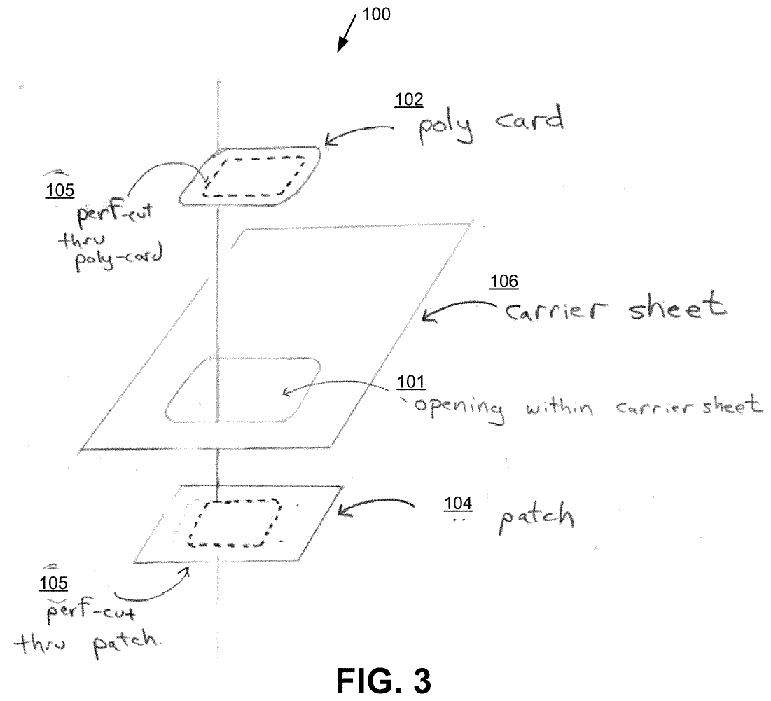

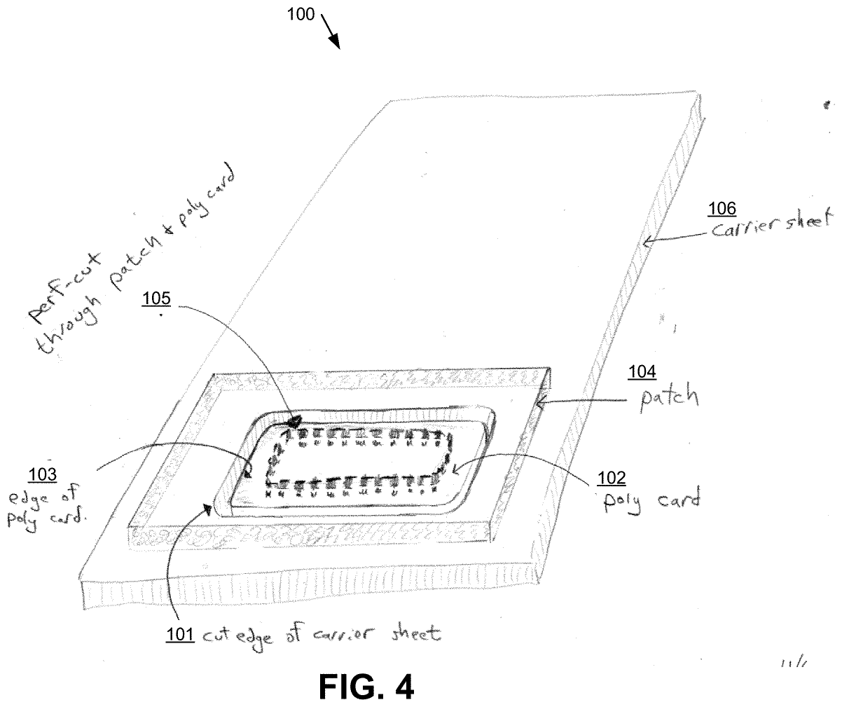

FIGS. 1-6 illustrate implementations of an example inkjet based roll with punch-out cards 100 according to the present disclosure. As shown in FIGS. 1-6, in some implementations, the inkjet based roll with punch-out cards 100 comprises a carrier sheet 160 having a top side and a bottom side.

In some implementations, the carrier sheet 160 comprises cut-outs 110. In some implementations, for each cut-out 110, a patch/tape 140 is applied to the bottom-side of the carrier sheet 160 to cover the cut-out 110 and attach a card (e.g., a polyester plastic card) 120 to the patch 140 through the cut-out 110 from the top side of the carrier sheet 160.

As shown in FIGS. 1-6, in some implementations, the card 120 and the patch 140 comprise perforations 150. In some implementations, the perforations 150 are made through the patch 140 and then through the card 120 (e.g., the perforations 150 are made from the bottom-side of the carrier sheet 160).

In some implementations, the cut-outs 110 are placed such that the inkjet based roll with punch-out cards 100 may be subsequently cut to produce two 8½ inch×11 inch sheets side by side (e.g., 2-wide) with at least one punch-out card 120 in each sheet, such as shown in FIGS. 1-6.

In some implementations, the gap/registration dimension between the cut edge 110 of the carrier sheet 160 and the edge 130 of the card 120 may be very narrow. For example, in some implementations, the registration is around or about 1/64 inch or less.

In some implementations, the registration is 1/64 inch. In some implementations, the registration is greater than 1/64 inch.

In some implementations, the patch/tape 140 is composed an opaque material having an adhesive on a first side on which the card 120 is adhered. In some implementations, the adhesive is a pressure sensitive adhesive.

In some implementations, the patch/tape 140 comprises an inkjet receptive coating on a second side opposite the first side.

In some implementations, during the method of manufacturing the inkjet based roll with punch-out cards 100, the adhesive is not dried by ultra-violet (UV) light.

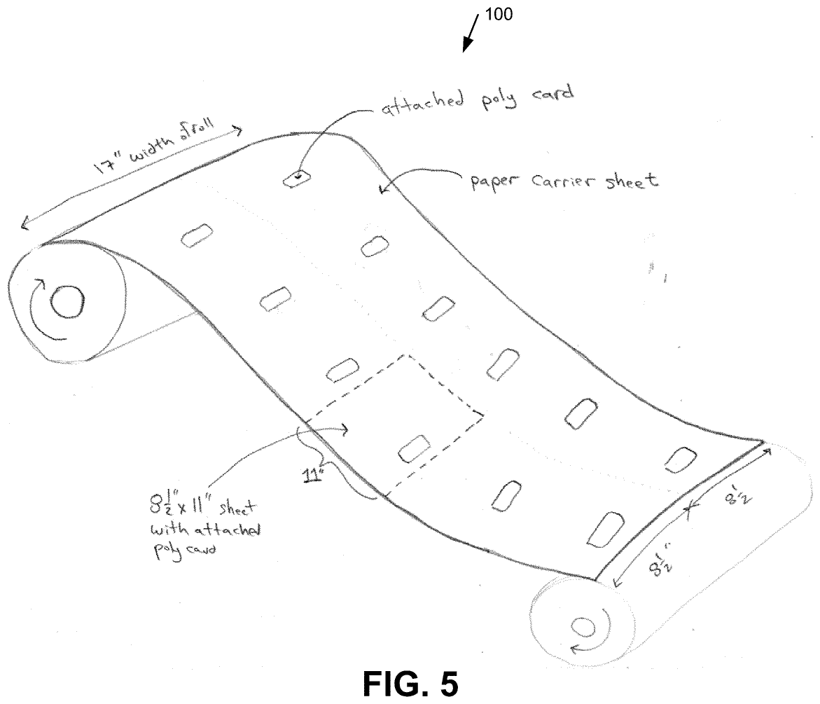

In some implementations, the inkjet based roll with punch-out cards 100 comprises any suitable dimensions. For example, as shown in FIG. 5, in some implementations, the roll is greater than 11 inches in width. In some implementations, the roll is at least 17 inches in width.

In some implementations, the inkjet based roll with punch-out cards 100 is composed of any suitable materials. For example, in some implementations, the inkjet based roll with punch-out cards 100 is composed of any suitable metal, plastic, etc. material.

In some implementations, the inkjet based roll with punch-out cards 100 can have any suitable appearance, such as shown in the figures.

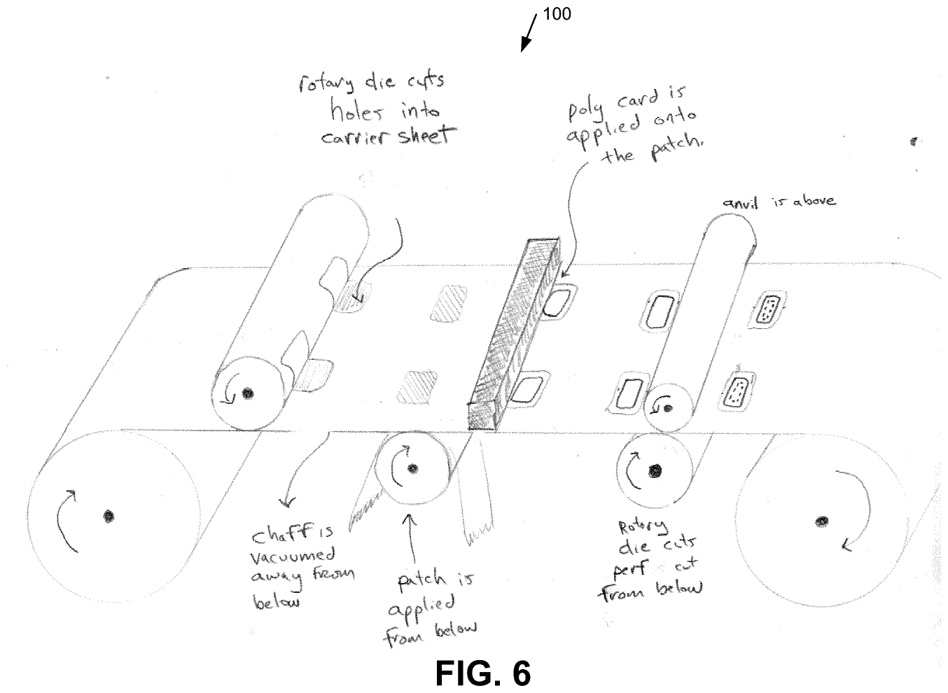

In some implementations, the figures (e.g., FIGS. 5 and 6) also illustrate an implementation of an example method for making the inkjet based roll with punch-out cards 100 of the present disclosure.

For example, in some implementations, a method of manufacturing the inkjet based roll with punch-out cards 100 comprises cutting a plurality of holes in a roll of a carrier sheet 160 where the carrier sheet has a top side and a bottom side. In some implementations, the method further comprises applying to the bottom-side of the carrier sheet 160 a patch/tape 140 to cover the cut-out 110.

In some implementations, the method further comprises attaching a card (e.g., a polyester plastic card) 120 to the patch through the cut-out 110 from the top side of the carrier sheet. In some implementations, the method further comprises perforating the patch 140 and the card 120 from the bottom-side of the carrier sheet 160. In the method, in some implementations, UV light is not used to dry the adhesive of the patch/tape 140.

In some implementations, the manufactured inkjet based roll with punch-out cards 100 can be fed into a press, printed thereon, cut, etc.

The figures, including photographs and drawings, comprised herewith may represent one or more implementations of the inkjet based roll with punch-out cards.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A method of manufacturing a roll to produce a plurality of punch out cards on the roll, the method comprising,
cutting a plurality of holes in a roll of a carrier sheet to form a plurality of cut-outs through the carrier sheet where the carrier sheet has a top side and a bottom side;
for each cut-out, covering the cut-out from the bottom-side of the carrier sheet by applying to the bottom-side of the carrier sheet a first piece of material;
for each cut-out, adhering within the cut-out a second piece of material in the form of a card to the first piece of material through the cut-out from the top side of the carrier sheet; and
perforating the first piece of material and the second piece of material from the bottom-side of the carrier sheet such that the cut is made first through the first piece of material and then the second piece of material.

2. The method of claim 1 wherein the first piece of material comprises an adhesive on a first side of the first piece of material on which the card is adhered and is configured such that the second piece of a material is releasably attached to the first piece of material.

3. The method of claim 1 wherein the first piece of material is made from an opaque material having an adhesive on a first side of the first piece of material on which the card is adhered.

4. The method of claim 2 wherein the adhesive is a pressure sensitive adhesive.

5. The method of claim 3, wherein the first piece of material comprises an inkjet receptive coating.

6. The method of claim 3, wherein the adhesive is not dried by ultra-violet (UV) light.

7. The method of claim 1 further comprising feeding the manufactured roll into a press, printing on the roll including the, and cutting the roll.

8. The method of claim 1 wherein the roll is at least 17 inches in width and the cut-outs are formed on the roll such that when the roll is cut to produce two 8½×11 sheets side by side widthwise across the roll, each sheet includes at least one punch-out card.

9. The method of claim 1 wherein the second piece of material is a polyester plastic card.

10. The method of claim 1 wherein the second piece of material is made from plastic.

11. The method of claim 1 wherein for each cut-out, the distance between an edge of the cutout and a nearest edge of the second sheet of material in the cut-out is or about 1/64 inches or less.

12. A roll made from the method of claim 1.

13. A method of manufacturing a roll to produce a plurality of punch out cards on the roll, the method comprising,
cutting a plurality of holes in a roll of a carrier sheet to form a plurality of cut-outs through the carrier sheet where the carrier sheet has a top side and a bottom side wherein the roll is at least 17 inches in width and the cut-outs are formed on the roll such that when the roll is cut to produce two 8½×11 sheets side by side widthwise across the roll, each sheet includes at least one cut out;
for each cut-out, covering the cut-out from the bottom-side of the carrier sheet by applying to the bottom-side of the carrier sheet a first piece of material wherein the first piece of material comprises an adhesive on a first side of the first piece of material on which the card is adhered and is configured such that the second piece of a material is releasably attached to the first piece of material and wherein the first piece of material is made from an opaque material having an inkjet receptive coating and wherein the adhesive is not dried by ultra-violet (UV) light;
for each cut-out, adhering within the cut-out a second piece of material in the form of a card to the first piece of material through the cut-out from the top side of the carrier sheet wherein the second piece of material is made from plastic; and
perforating the first piece of material and the second piece of material from the bottom-side of the carrier sheet such that the cut is made first through the first piece of material and then the second piece of material.

14. The method of claim 13 wherein for each cut-out, the distance between an edge of the cutout and a nearest edge of the second sheet of material in the cut-out is or about 1/64 inches or less.

15. A roll made from the method of claim 13.

16. A method of manufacturing a roll to produce a plurality of punch out cards on the roll, the method comprising,
cutting a plurality of holes in a roll of a carrier sheet to form a plurality of cut-outs through the carrier sheet where the carrier sheet has a top side and a bottom side wherein the roll is at least 17 inches in width and the cut-outs are formed on the roll such that when the roll is cut to produce two 8½×11 sheets side by side widthwise across the roll, each sheet includes at least one cut out;
for each cut-out, covering the cut-out from the bottom-side of the carrier sheet by applying to the bottom-side of the carrier sheet a first piece of material wherein the first piece of material comprises an adhesive on a first side of the first piece of material on which the card is adhered and is configured such that the second piece of a material is releasably attached to the first piece of material and wherein the first piece of material comprises an inkjet receptive coating;
for each cut-out, adhering within the cut-out a second piece of material in the form of a card to the first piece of material through the cut-out from the top side of the carrier sheet wherein the second piece of material is made from plastic and wherein the distance between an edge of the cut-out and a nearest edge of the second sheet of material in the cut-out is or about 1/64 inches or less; and
perforating the first piece of material and the second piece of material from the bottom-side of the carrier sheet such that the cut is made first through the first piece of material and then the second piece of material.

17. A roll made from the method of claim 16.
